(19) United States
(12) Patent Application Publication
(10) Pub. No.: US 2020/0331579 A1
(43) Pub. Date: Oct. 22, 2020

(54) portable mixing apparatus for ballast water treatment

(71) Applicant: Barnaby Jude Watten, winchester, WV (US)

(72) Inventor: Barnaby Jude Watten, winchester, WV (US)

(21) Appl. No.: 16/388,872

(22) Filed: Apr. 19, 2019

(51) Int. Cl. B63J 4/00; C02F 1/00; C02F 1/66

(52) U.S. Cl. CPC B63J 4/004; C02F 2103/008; C02F 1/66; C02F 1/006

(57) ABSTRACT

A portable apparatus and process for treating and mixing ballast water. The apparatus is a lightweight, easily transportable air sparger that serves as a backup treatment system in the event of failure of a Ballast Water Maintenance System or in an emergency or when an unregulated vessel arrives in port with a filled tank. The sparger is operated with compressed air passing through arms and hoses extending from a central hub. Fluids exiting arms produce streams at various levels circulating and mixing ballast water, minimizing energy consumption.

### CROSS-REFERENCE TO RELATED APPLICATIONS

This patent application claims the benefit of U.S. Provisional Application No. 62/631,951 filed Feb. 19, 2018.

### FIELD OF INVENTION

This invention relates to the field of treatment of wastewater or sewage and more specifically to a system for treating ballast water.

### BACKGROUND OF THE INVENTION

The U.S. Geological Survey (USGS) is a bureau of the Department of Interior which provides scientific data for the management of U.S. environmental resources. The USGS has conducted advanced research and develops technologies to control the threat to U.S. marine ecological systems by invasive species, such as Asian Carp and Zebra Mussels.

Ballast water discharge is recognized as the leading source of invasive species in U.S. marine waters, posing public health and environmental risks, as well as significant economic cost to industries and utilities. The introduction of invasive mollusks alone (e.g., zebra mussels) is estimated to cost the U.S. more than $6 billion per year. More than 7000 marine species travel daily, and approximately 10 billion tons of ballast water are transported annually by ship. There are 40,000 commercial carrier vessels worldwide. A single vessel can transport in excess of 200,000 m3 of ballast annually, which may release into a local eco-system at port.

In 1996, Congress passed the Non-Invasive Species Act (NISA) to control the spread of aquatic nuisance species, partly in response to the threat of invasive Zebra mussels. The U.S. Coast Guard is charged with implementing regulations requiring that commercial vessels be equipped with onboard ballast water treatment systems. The Coast Guard began formal certification of Ballast Water Management Systems (BWM Systems) in 2016. A permanent BWM System is estimated to cost between one and five million dollars.

A certified BWM System may rely on chemical reagents to treat ballast water to kill invasive species. This process is known in the art as “tank dosing.” Typical chemical reagents used for tank dosing include hypochlorous acid and chlorine gas. Coast Guard regulations require that each approved BWM include a “means to ensure that any maximum dosage or maximum allowable discharge concentration of active substances and preparations is not exceeded at any time.”

Known chemical reagents or biocides are typically introduced into a ballast tank as turbulent water enters ballast tank pipelines to fill the tanks. The reagent remains in the tank for the duration of a ship's journey. The chemical reagents must be neutralized by known neutralization agents prior to releasing ballast water for ballast water compliance. It is therefore desirable to treat ballast water using the lowest effective amount of potentially toxic chemical reagents.

Approved BWM Systems must include a control unit which automatically monitors and adjusts dosages. BWM Systems are also required to implement emergency manual override systems to add and mix chemical reagents directly to ballast water in the event of system failure.

Mixing of ballast water is critical to effective and legally compliant tank dosing. Once an active substance or preparation is introduced into a ballast tank, it must be mixed with the water to ensure uniform distribution and effective levels. Effective amounts of the treatment solution must come into contact with all potentially contaminated surfaces and waterborne invasive species for an effective amount of time.

Methods for mixing water in tanks as part of a treatment process have been developed to treat wastewater from municipal sewage systems, manufacturing, and industry. These treatment methods generally incorporate large circular or square tanks to hold the water during treatment, mixing, and neutralization (if required) before the water is released. These tanks generally lack geometric complexity and are therefore relatively easy to mix using a variety of mechanical methods (i.e., axial mixers, eductors, air, and nozzles). The ballast tanks on ships are quite different. The tanks are engineered to be part of the structure of the ship and are integral to the stability and integrity of the ship.

As a result, most ships have multiple ballast tanks (ranging in number from a few to dozens) that are geometrically complex and often have baffles, support structures, web frames, stringers, stations, piping, and rose boxes inside the tanks. Also, there can be different types of ballast tanks with different geometries on a single ship. This complexity makes it difficult to mix the water in the tanks as part of a treatment method. Moreover, about 70,000 cargo ships are operating worldwide. It would cost the shipping industry billions of dollars to install and maintain permanent mixing systems in all ballast tanks on all ships.

It is known in the art that bubble plumes can be used and are effective in mixing and moving large volumes of water. A bubble plume is produced from a point source that produces bubbles that rises or lifts through an ambient fluid composed of two layers of fluid of different density. In the lower layer, the bubbles rise to the top of the system, while the lower layer fluid in the fountain rises a finite distance into the upper layer, entrains some of the upper layer fluid, and then collapses. This effect shall be referred to as airlift. This mixture of fluids creates turbulence which creates a turbulent effect as well as the bulk movement of ballast water within a tank.

A common problem for distribution or mixing is that it must be accomplished for large volumes of water and that the internal structures of ballast tanks typically include structures known to retard mixing. Structures such as transverse web frames, stringers, stanchions, piping, and double bottom sections may come into only limited contact with dosed water in the ballast tank. Conventional approaches to achieving mixing include costly, permanent mixing apparatus within the tank.

Where vessels lack permanent mixing components within its tank or find that its component is inadequate or becomes defective, there is an need for a low cost, lightweight, portable, easily deployable BWMS systems capable of providing various fluids in water to provide effective and legally compliant dosing levels within ballast tank water, gas transfer and mixing of chemicals when needed.

The invention described herein avoids many of the shortcoming mentioned above resulting in a portable, inexpensive BWMS backup technologies which can be rapidly deployed in the event of BWMS system failure and is capable of treating full or partially full tanks of managed or unmanaged vessels that are in or arrive in U.S. ports that may or may not have unique configured tanks.

### SUMMARY

With the implementation of the invention, the above problems are solved by providing a portable mixing apparatus and method for treating ship ballast water. The apparatus is lightweight and includes a gas inlet connected to a central hub with extending arms having multiple orifices to release fluids.

The sparger may be lowered into ballast tank water. A fluid is passed through the sparger's arms. The arms rise with the discharge of fluids. Reagents and chemical inserted in the water are mixed from resulting airlift produced from fluids discharged from the arms.

In operation, the portable air sparger may be lowered into the tank by a cable system (with attached air or fluid delivery line) to a target depth of the ballast water tank. Reagents may be added directly to the tanks via deck penetration(s) or other tank access sites before, during or after the initiation of airflow or mixing. Upon completion of the biocide treatment or biocide neutralization step, airflow is terminated, the sparger arms then retract to a position within the sparger housing, by gravity, allowing the unit to be pulled out and recovered without becoming entangled in ballast tank structures. The sparger is then activated by initiating airflow with the arm extending outward and operated on a continuous or semi-continuous basis until the volume of the tank becomes homogeneous with regards to water chemistry.

The apparatus is inexpensive, so several units may be operated concurrently within and amongst the tanks being treated to reduce the time required for treatment.

The portable air sparger also may mix salt and freshwater during ballast water exchange operations while concurrently facilitating gas absorption or gas stripping. Airlift pumps, where an airlift produces bubbles and entrained water extending above the surface water and collapsing with high impact, appear attractive in shipboard applications given their ability to efficiently move large volumes of water with little or no backpressure, the absence of moving parts, and the potential for operating a number of airlifts off of a single low to moderate pressure air source. The sparger may water free of sediment, bodies with high suspended solids concentrations as well as water containing oils or other flammable liquids.

The sparger may be deployed quickly as a lightweight tool that serves to mix the contents of ship ballast tanks based simply on the application of air emanating from perforated sparger arms designed to extend with the application of air.

The apparatus and process provide an inexpensive, lightweight, portable sparger that serves as a source for fluids such as gas or air into a ballast tank that can provide complete and rapid mixing of the ballast tank contents with the treatment of reagents despite varying ballast loads or ballast tank geometries.

### BRIEF DESCRIPTION OF THE DRAWINGS

Various aspects and advantages of the invention will be apparent from the following detailed description, taken in conjunction with the accompanying drawings. The drawings are not necessarily drawn to scale. In the drawings:

FIGS. 1A and 1B illustrate a side of the portable mixing apparatus called an air sparger.

FIG. 2 illustrates a top view of a portable air sparger with arms extended.

### TERMS OF ART

As used herein, the term “arm” means an extension, protuberance or elongated structure which provides an extended cross-sectional area for air sparging.

As used herein, the term “cross-sectional area” means a submerged horizontal area within the tank over which gas is dispersed.

As used herein, the term “geometrically optimized” means that a component has dimensions and/or physical features or has been adapted to produce an optimum bubble, plume size, and airlift.

As used herein, the term “mixing rate” or “target mixing rate” refers to the amount of time or frequency at which a biocide or reagent is dispersed, uniformly, within the entire contents of the ballast tank.

As used herein, the term “airlift” means a column or bubble plume of a fluid moving or lifting upward through another with a different velocity to a peak distance where the bubble reaches the top and collapses producing turbulence sufficient for bulk water circulation.

As used herein, the term “sparger” means a fluid delivery system.

As used herein, the term “swivel” means movement between two components wherein one component is structurally configured to revolve without turning the other.

### DETAILED DESCRIPTION OF THE INVENTION

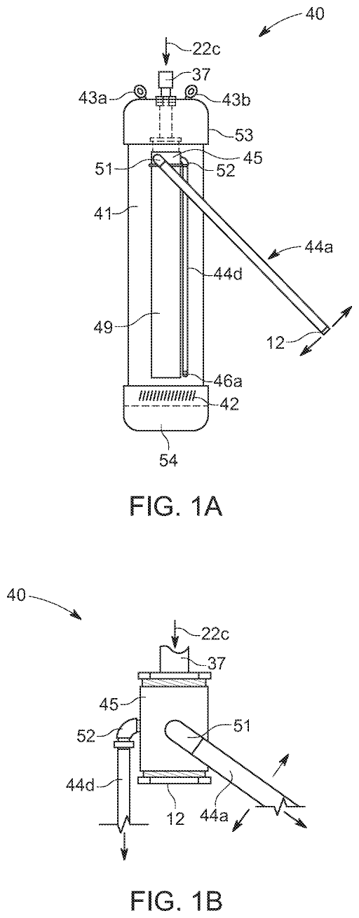

FIG. 1A is a side view of a portable sparger to be lowered into a ballast tank through depth adjustment components 43a-b attached to top housing cap 53. The sparger 40 is supplied air pressures from known blowers, centrifugal compressors, screw type compressors or on board compressors often used to support normal ship board operations (not shown) that is connected by a feed line (not shown) to a gas inlet 37, connected to central hub 45, with vertical arm or port hose 44d and arm 44a, that are hollow tubular components or pipes that pass pressurized fluid or air 22c from the gas inlet 37, port hose 44d, provides a geometrically optimized outlet orifice or nipple 46a to pass a fluid at lower portion of the sparger 40. Housing 41 surrounds the central hub 45, containing an elongated slot 49 that arm 44a, shall be positioned within (not shown), with a lead weight or orientation guide 42 attached to bottom housing cap 54 at lower end of housing 41, to keep sparger 40, aligned in a vertical position while being lowered in a tank. Port hose 44d and arm 44a operatively coupled to central hub 45, by swiveling elbow 51, and a fixed elbow 52.

After the sparger is submerged to a predetermined depth into ballast tank water, pressurized fluid or air 22c, enters gas inlet 37 and exit through outlet geometrically optimized outlet orifices 46a, to creates thrust and causes each arm 44a, which are pivotally or movably attached to swiveling elbow 51 to swivel from a closed vertical position to an open horizontal position, through elongated slot 49. Each arm 44a (arms 44b-c not shown) spaced apart by 120 degrees.

In the exemplary embodiment shown, sparger 40 is lowered into a ballast tank to a predetermined depth based desired airlift and mixing effect. Arm 44a is in a vertical resting position within housing 41. This resting position allows housing 41 to protect arm 44a from becoming entangled in structural components within the ballast tank. Additionally, arm 44a bundled within housing 41 of the apparatus, allow sparger 40 to lowered, through a confined space into a ballast tank. In various embodiments, attachment points and the use of lead weight or orientation guide 42 at the base of the apparatus help to stabilize and keep the body of the unit in the vertical position during all phases of its deployment/operation.

FIG. 1B is a side view of a sparger 40 with central hub 45 coupled to port hose 44d which may be rigid, or a flexible hose fixed in the downward position by fixed elbow 52 with an air release opening or nipple 12 at its outermost end. The sparger is activated by passing fluid through sparger 40 gas inlet 37. The fluid source in a preferred embodiment is an air compressor. Optionally, a secondary gas source may provide a second fluid to sparger arms to be mixed with the primary fluid.

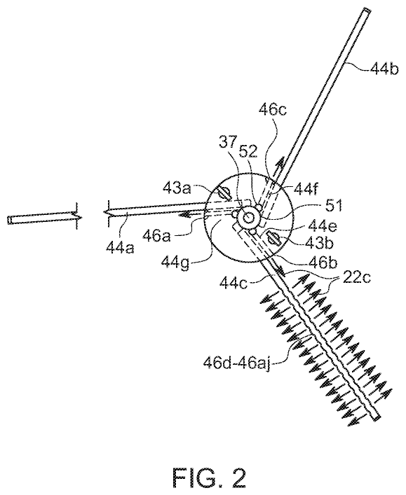

FIG. 2, illustrates a top view of sparger 40 with arms 44a-c in an extended position.

In one exemplary embodiment, port hoses 44e-f may be connected to a reservoir that releases a chemical agent neutralizing agent during operation of the sparger 40. The reservoirs (not shown) may contain the same any combination of biocides, reagents or neutralizing agent which can be introduced by pumping, directly into the airline of the primary fluid feeding vertical port hoses 44d-f and arms 44c-f assembly to eliminate the need for a separate secondary delivery line.

Depth adjustment components 43a-b are movably attached to cables use to mechanically lower and raise sparger 40 into and out of the ballast tank. In some uses, access to tanks may be through panels or cut out holes in the ship deck.

The lift is determined by the pressure drop across geometrically optimized outlet orifices and total air flow Qₐₘ as well as the dimensions of arms 44a-c and resistance to the arm moving related to the fitting used in the swing arm of the portable apparatus. In the exemplary embodiment shown, gas inlet 37 receives pressurized fluid or air 22c that will exit through geometrically optimized outlet orifices 4d-aj creating thrust. This thrust force will cause arms 44a-c, due to pressure and positioning of the geometrically optimized outlet orifices 4d-aj to pivot to the open position,

The horizontal position of arms 44a-c increases the cross-sectional area of the pressurized fluid or air 22c that exit arms 44a-c along with placement of the orifices directing airflow to left and right of the arm and submergence depth that also improve the water moving/pumping rate of the bubble plume developed. Optionally, airlift may be enhanced by additional vertical arms or port hoses 44d-f connected to central hub 45 by fixed elbow 52 placed between arms 44a-c. Vertical arms or port hoses 44d-f provide secondary pressurized fluid or air 22c generated between and at a lower position than arms 44a-c. Secondary stream exits at a geometrically optimized outlet orifices 46a-c formed at the lower end point of vertical arms or port hoses 44d-f to aid in meeting target mixing rate.

Pressurized fluid or air 22c is discharged through geometrically optimized outlet orifices 46a-j, forces the water to move in controlled plumes, which results in a target agitation rate. Thus, even if an obstacle in the ballast tank obstructs arms 44a-c from pivoting to an open position, sparger 40 may still achieve the target agitation rate.

In various embodiments, sparger 40 may be deployed for emergency use.

In various embodiments, components of sparger 40 can be scaled, based on ballast and tank volume and or the target duration of the mixing operation larger tank volumes will require larger spargers and higher air feed rates than smaller tank volumes. The model described operated on an air compressor delivering about 185 cubic feet per minutes of air at about 80 psi. Air feed rates are related to sparger design and will increase with the number of orifices and orifice size used in the construction of the sparger arms and the shell-based air release points.

Operating pressures of the air delivery system are important as it determines, along with air flow rate, the power required for the compression step. Pressure requirements will be related to air delivery piping and orifice size. Thrust development of the sparger arms with airflow must also be considered when designing the air delivery and release components of the apparatus. Thrust must be sufficient to elevate the sparging arms to the horizontal position when the unit is submerged.

In one exemplary embodiment, sparger 40 includes housing 41 polyvinyl chloride (PVC) pipe having an outside diameter (OD) of an 8″×40″ with bottom housing cap 54 containing a (50 lb) lead weight or orientation guide 42, to keep sparger in a vertical position during lowering and use in a ballast tank. A 8″ PVC top housing cap 53 having 2″ OD, eye nut attachment points as depth adjustment components 43a-b with a gas inlet 37 that is a 1″ threaded coupling that connects to gas supply hose or feed (not shown) passing through top housing cap 53.

Elongated slot 49 measures 3″×28″ to allow air released from vertical arms or port hoses 44d-f to housing 41. Arms 44a-c sit within a single slot 49. Swiveling elbow 51 and fixed elbow 52 shown may be threaded and attached to a threaded pipe nipple extending from the side of the central hub 45. Bottom of central hub 45, may be a 2″×1″ threaded bushing blocked from fluid release by a 2″ PVC threaded plug in air release opening or nipple 12. Arms 44a-c may be attached to swiveling elbow 51, by a 1″ PVC threaded elbow fitted loosely on a threaded nipple to allow arms 44a-c to swivel. Arms 44a-c may be hollow tubes or pipes made of a 1″×25″ PVC pipe that are capped at their far most ends having a plurality of outlet orifices along its side surfaces.

Arms 44a-c, may each contain thirty-one, ⅛″ orifices or holes spaced at 1½″ and offset at an angle of 30 degrees from the horizontal. Port hoses 44d-f may be ⅝″ connected to an end of hose barb designed to accept rubber hoses with a threaded nipple connected to fixed elbow 52, attached to central hub 45.

Geometrically optimized outlet orifices 46a-j have ⅛″ diameters and are spaced 1½″ inches apart along the length of the pipe, offset by a 120-degree angle from the nearest orifice.

Sparger 40 is geometrically optimized based on predetermined design parameters including energy consumption and mixing time.

Airlift or bubble plume mixing potential will rise with increases in bubble sparging cross-sectional areas, air feed rates, decreasing bubble size, increasing depth of air release and with use of multiple air release sites. Further, placement of the sparger(s) may establish transverse rolling action or large circulation cells known to enhance mixing.

The mixing time is achieved by establishing a target mixing rate. The target rate correlates airflow, sparger dimensions, and ballast tank volume/geometry with required mixing time. The mixing rate will vary based on the amount of power used to conduct air through port hoses 44d-g and arms 44a-c and the cross-sectional area formed by arms 44a-c and vertical port hoses 44d-f. Where it is determined that larger cross-sectional areas are needed, sparger will require adjustment of more airflow, larger compressor units, and power output to operate the sparger.

Sparger arms are designed to accommodate a selected air flow rate, air pressure drop and thrust required to extend arms. Selected air flow rates are determined empirically for a given tank design, the desired number of spargers in operation per tank and rate of mixing required. Individual orifice dimensions should be selected to pass particulate matter present in either the compressed air supply used or that found in the water being treated. Orifice spacing should achieve a near uniform distribution of air along the length of the arm despite pressure drops resulting from fluid friction within the arm.

Arms 44a-c contain a plurality orifice on alternate sides of arms 44a-c forming two parallel rows of orifices wherein each orifice 44d-aj are offset from the other by 120 degrees as shown in FIG. 2. Each orifice is placed along the curvature of arms 44a-c to generate bubble plumes between each of the arms used. The angles used must provide the thrust vectors needed to lift the arms into their upright positions. Thrust requirements are related to the geometry of the arms, particularly the length and diameter as well as materials of construction. Friction on the swiveling elbow 51 used to attach the arms 44a-c to the central hub 45 must also be considered in calculating thrust requirements. Thrust developed by air exiting the individual orifice selected is correlated with air velocity and air mass flow rate as predicted by a standard formula. Water is displaced from the arms when air is applied generating a buoyancy force that assists in elevating the arms 44a-c to the perpendicular position during operation

The number of geometrically optimized outlet orifices 46d-j, may be altered to produce an optimized or altered air flow. The number of holes is determined by the target airflow level divided by the predicted airflow per orifice.

The spacing of the geometrically optimized outlet orifices 46d-j is determined by the number of arms 44a-c, as well as the diameter of geometrically optimized orifices 46a-c.

Dependent on design needs, various factors are controlled for optimization of the sparger and its performance including gas feed rates to the sparger 40 and gas release orifice's sizes for a specific power requirement or gas transfer rate target.

Air feed rates are regulated with valving, and the minimum air flow required to initiate airlift and pumping effect where the bubbles entrained in water in airlift extend above the ballast tanks surface water and collapse turbulently are related to the orifice diameters and the submergence ratio:

$${Q}_{am} = \frac{0.35 ( 1 - {M}_{s} ) A \sqrt{gd}}{1.2 {M}_{s} - 0.2}$$

Where Qₐₘ=minimum air flow required to start pumping (cm³/s)
Mₛ=submergence ratio hs/hm (m/m)
A=cross-sectional area of the airlift pipe (cm²)
g=acceleration of gravity (cm/s²)
d=diameter of airlift pipe (cm)

The orifices discharge a fluid in the ballast water producing a current resulting in bubbles in the water. The bubble size is related to the sparger orifice diameter and the density of the gas at the release point. Bubbles influences within the water not only pumping capacity but also the potential for gas transfer. Relatively small bubbles reduce “slip” or the relative velocity difference between the rising bubble and the liquid, which in turn, reduces the energy loss in an airlift. Smaller bubbles also provide more gas-liquid interfacial area per unit volume of water pumped which can be important when the airlift is used during treatment for gas absorption or stripping. Bubble flow will occur only if the gas-liquid ratio is less than 0.1. Above that level, bubble coalescence occurs due in part to turbulence and gas expansion as the gas-liquid mixture proceeds towards the discharge end of an arm.

These bubble sizes are related to the sparger orifice diameter and the density of the gas at the release point.

$${R}_{b} = {0.875 [ \frac{( St ) ( {R}_{0} )}{g ( {ρ}_{e} - {ρ}_{g} )} ]}^{1 \text{/} 2}$$

where R_{b}=bubble radius (cm)

St=surface tension (g cm/s²)

R₀=orifice diameter (cm)

g=acceleration of gravity (cm/s²)

ρₑ=density of liquid (g/cm³)

ρ_{g}=density of gas (g/cm³

A decrease in the orifice diameter R₀, or an increase in the depth of submergence of the air inlet to the pumps, will increase the energy required to operate the airlift. The power required to compress a selected mass of air, Qₘ, increases with the compression ratio as described by the adiabatic compression formula:

$$Pw , compressor = \frac{{Q}_{m} {RT}_{1}}{Ne} [ {( \frac{{P}_{O}}{{P}_{I}} )}^{N} - 1 ]$$

Where Qₘ=Mass flow rate of gas (kg/s)

R=Gas constant

T₁=Absolute temperature of gas at compressor inlet (° K)

N=(K−1)/K, dimensionless

e=Combined efficiency of compressor or pump and motor

P_{O}=Absolute compressor outlet pressure (kPa)

P_{I}=Absolute compressor inlet pressure (kPa)

P_{w}=Power required (kW)

K=Isentropic index for gas mixture, dimensionless

Hydraulic efficiency of airlift is important as it affects energy requirements for ballast mixing. Efficiencies can approach 50 to 60% and is related to a number of design variables including the flow of both gas and liquid, the submergence ratio, eductor diameter, and discharge head as well as gas release orifice size as just discussed. Overall performance correlations have been developed for airlift pumps based on two-phase flow theory and/or by modeling empirical data. For example, the empirical model of Henderson and Perry (1955) gives the volume of air required to pump water versus lift, depth of submergence and a constant based on lift:

$$Q = \frac{0.8 {h}_{1}}{C {log}_{10} ( {h}_{2} + 10.36 ) \text{/} 10.36}$$

where Q=cubic meters of air required to lift 1 liter of water

h₁=lift (meters of water)

C=empirical constant (9981-6355)

h₂=depth of submergence (meters of water)

While sparger 40 provides the ability to mix reagents added into the ballast tank, sparger 40 may be used alternately in an emergency as a primary source to add a reagent to a ballast tank through a feed line passing fluids through its gas inlet 37 and geometrically optimized outlet orifices, 46a-aj. By controlling bubble size and air flow, gas-filled bubbles can collapse prior to fully rising dosing water to achieve desired BWS effect. Relatively high volumes of low-pressure gas or gas mixtures may be forced through orifices designed to generate gas bubbles needed to provide both the gas/liquid surface area necessary for gas transfer as well as the airlift potential needed to concurrently mix the contents of the ballast tank. Sparger 40 may act as gas absorbers or strippers based on varying the gas-liquid interfacial area within the sparger by creating a temporary increase in gas solubility due to elevated hydrostatic pressures as well as the establishment of high levels of turbulence that increase the local gas transfer coefficient.

The apparatus is used in a process to circulate ballast water and to mix chemicals within the ballast water to eliminate invasive species. Circulation of the ballast water and the mixture of chemicals is achieved without removing the ballast water from the ballast tank. The process is capable of meeting various design needs concerning mixing time and energy use by controlling factors identified above to achieve predetermined targeted goals.

Advantages of sparger 40 include simple performance modifications by varying air feed rate, use of radial arm extensions that improve performance by applying air for mixing over a large cross-sectional area of the tank, ability to achieve gas transfer while mixing, minimizes the size of the deck penetrations needed to deploy the air diffuser within the tank, and compatibility of use in a variety of ballast tank configurations.

Alternative embodiments may include; (1) spring action linked to a remote trigger with the springs housed within the shell of the assembly, (2) pneumatic cylinders linked to the diffuser arms and activated by the air supply pressure that develops upon activation of the sparging arms, (3) use of hydraulic cylinders receiving activation flow and pressure from a remote fluid reservoir or pressurized water line, (4) use of a trigger cable or string line that extends from the ship deck to the assemblies arms via a cam or other mechanical linkage, (5) a rack and pinion assembly with pinion rotation provided by an electric motor, a hydraulic motor or a pneumatic motor, and (6) a rotary screw and or jack assembly again with rotation of the screw provided by an electric motor, a hydraulic motor or a pneumatic motor.

It will be appreciated by those skilled in the art that modifications and variations of the present invention such as changes in material, geometry and number of used spargers to accommodate design needs, such as speed in mixing, sizes of tanks are possible without departing from the principles and spirit of the invention, the scope of which is defined in the appended claims and their equivalents.

What is claimed is:

1. A portable air sparger apparatus for treatment of ballast water, comprised of:
a sparger housing;
a gas inlet;
a housing substantially enclosing a sparger hub; and
a plurality of sparger arms having a plurality geometrically optimized outlet orifices.

2. The apparatus of claim 1 which further includes a sparger housing;

3. The apparatus of claim 2 wherein said sparger housing includes three adjacent slots, and wherein each said plurality of sparger arms is movably positioned within of said at least three adjacent slot

4. The apparatus of claim 2, wherein between each of said arm is a hose connected to said hub, extending downward along body of said housing that passes air from said gas inlet.

5. The apparatus of claim 3 further including a nipple attached at an end of said hose; wherein said nipple extends through said housing.

6. The apparatus of claim 1 wherein each of said plurality of sparger arms include two parallel rows of geometrically optimized orifices.

7. The apparatus of claim 5 wherein each of said plurality said geometrically optimized outlet orifices are spaced approximately 1½″ inches apart along the length of each of said geometrically optimized sparger arm; and offset by a 120-degree angle from the nearest orifice.

8. The apparatus of claim 1 wherein each of said geometrically optimized outlet orifices are positioned to enable upward movement of said sparger arms when pressurized fluid or air is introduced.

9. The apparatus of claim 1 wherein said plurality of geometrically optimized outlet orifices are optimally configured to maximize the cross-sectional area containing orifices to form bubble plumes.

10. The apparatus of claim 1 which further includes a component selected from a group consisting of a lead weight or orientation guide component for keeping said hub of said sparger vertical when lowering.

11. The apparatus of claim 10 further includes a cap comprising means for lowering sparger, attached to a top of said housing; and said weight attached to bottom of said housing.

12. The apparatus of claim 1 which further includes at least three swiveling elbows that rotate move said arms between an open to the closed position

13. The apparatus of claim 1 wherein said sparger is comprised of materials that are at sufficient thickness and strength to be lightweight and to be able to withstand PSI produced by said pressurized fluid or air; said materials are selected from a group including steel, rubber, aluminum, metal alloy, PVC, or fiberglass.

14. The apparatus of claim 1 wherein each said sparger arm includes said cap to direct said pressurized fluid or air though said geometrically optimized orifice.

15. The apparatus of claim 1 wherein said sparger arms are operatively coupled with an actuating component selected from a group consisting of springs, pneumatic cylinders of hydraulic cylinders, a trigger cable, a rack and pinion assembly with pinion rotation provided by an electric motor, a hydraulic motor, a pneumatic motor, a rotary screw, and a jack assembly.
The method of using a portable sparger apparatus comprised of the steps of: causing a plurality of to move from a closed vertical position to an open horizontal position relative to a sparger hub;
adding a chemical to ballast water in a tank;
lowering a portable air sparger device into ballast water: and
injecting a pressurized gas stream into said gas inlet of said sparger hub to cause said stream to exit through said orifices and bubbles.

16. The method of claim 16 which further includes a chemical reservoir operatively coupled with said sparger.

17. The method of claim 16 wherein the step of lowering said sparger is done prior to a step of adding said chemical to said water; and said stream first adds said chemical into said water; and
wherein a second stream creates an airlift in said water mixing said chemical and said water to achieve a target mixing rate in said ballast tank.

18. The method of claim 16 which further includes the step of creating an airlift in said water to create a target mixing rate in said ballast tank.

19. The method of claim 18 further includes the step of directing pressurized fluid or gas through structures consisting of said orifices, nipples and outlets to increase airlift.

20. The method of claim 16, wherein between each of said arm is a hose connected to said hub, extending downward along body of said housing that passes air from said gas inlet; wherein said step of injecting said pressurized gas stream into said gas inlet of said sparger hub further includes said stream exiting from a nipple or orifice at the end of the hose increasing airlift.
